(19) United States
(12) Patent Application Publication
(10) Pub. No.: US 2021/0133243 A1
(43) Pub. Date: May 6, 2021

(54) SYSTEM FOR APPRECIATING AND RANKING USERS IN A SOCIAL NETWORKING SYSTEM AND METHOD THEREOF

(71) Applicant: Shaphron Technolabs Private Limited, New Delhi (IN)

(72) Inventors: Phoolendra Gangwar, Faridabad (IN); Ankit Kansal, Gurgaon (IN)

(21) Appl. No.: 16/726,402

(22) Filed: Dec. 24, 2019

(30) Foreign Application Priority Data
Nov. 5, 2019 (IN) 201911044836

(51) Int. Cl. G06F 16/906; G06F 16/9536

(52) U.S. Cl. CPC G06F 16/906; G06F 16/9536

(57) ABSTRACT

The present invention relates to a system (100) and method (200) for appreciating and ranking a user in a social networking system. The system (100) comprises a user-interface device (101) to share information and react to the information shared by one or more end-users. The system (100) comprises a processing unit (103) to execute a set of instructions provided in a plurality of modules in the system (100). The appreciation provided by one or more audience users for the information shared by the end-user is analyzed in an analysis module (106) to form a rank-based pattern in a plurality of categories which are compiled to form a comprehensive ranking in a ranking module (107). The popularity ranking of a user is displayed in a display unit (110) of the user-interface device (101).

### CROSS REFERENCE TO RELATED APPLICATIONS

The present application claims priority to Indian Application Serial No. 201911044836, filed Nov. 5, 2019, herein incorporated by reference in its entirety.

### DESCRIPTION OF THE INVENTION

### Technical Field of the Invention

The present invention relates to a system and method for appreciating and ranking a user in a social networking system. More particularly, the present invention relates to a system for providing an appreciation for the information shared by one or more end-users and identifying the ranking of one or more end-users based on the appreciation provided by one or more audience users in the social networking system.

### BACKGROUND OF THE INVENTION

In recent years, transformation in the web-based portals may be attributed to a major advancement in the field of information technology which has prompted people to rely on web-based portals in every walk of life. Information technology provides a medium such as a social networking system for users across the globe to connect, communicate, share multi-media information and so on.

However, the users of existing social networking systems have experienced a rise in hassle and cyber bullying of the users sharing information on the social networking system. For example, one or more users of a social networking system may provide invective comments for the information shared by a fellow user which may negatively impact the confidence of the fellow user. A survey conducted in 2013 revealed that two out of three participants of the survey under the age 22 are the victims of cyber bullying. Furthermore, cyber bullying not only affects the vulnerable users but also the resilient users of a social networking system thereby developing a negative trauma which might have severe repercussions such as suicidal tendency amongst the victims. The existing technologies fail to provide a system where a user is allowed to approbate fellow users by providing only positive feedbacks in a social networking system.

The U.S. Pat. No. 10,216,803B2 relates to a method which retrieving a plurality of comments associated with a content object on a social-networking system. The existing method determines a score for each of the comments provided in the social networking system, wherein the score is provided for the comments based on the identity and reputation of the user and content of the comment. The comments are ordered and presented to a target user based on the respective score generated in the social networking system. The method may further exclude one or more of the comments by employing a filtering condition. The comments may be ordered based on the reiteration of the likes, hidden, marked as spam, or replied to a comment within a specified period of time.

The U.S. Pat. No. 8,918,339B2 discloses a social networking system for a user to associate an emoji representing the user's emotional reaction with a content item presented in the social networking system. The user is provided with the option of selecting one or more emoji maintained by the social networking system for associating with the content item. Based on the type of emoji selected, the social networking system prompts the user or requests the user for compensation an entity associated with the selected emoji. Data of the content, selected emoji or other information is stored by the social networking system. The selected emoji may be displayed with the content item to the user and to other users connected to the user.

Hence, there is a need for a system to enable one or more users of a social networking system to appreciate the personality and/or information shared by the fellow users of the social networking system.

### SUMMARY OF THE INVENTION

The present invention relates to a system and method for appreciating and ranking a user in a social networking system. The system comprises a user-interface device for one or more end-users to share information associated with one or more events through the social networking system and react to the information shared by one or more end-users by providing an appreciation in the social networking system, wherein the information shared by one or more end-users may be in the form of a multi-media information, text, speech and so on. The system comprises a database to store the information shared by one or more end-users in the social networking system. Additionally, the system comprises a processing unit to process and execute a set of instructions provided in a plurality of modules to provide a creative response for one or more audience users in the social networking system.

A complimentary module provides one or more audience users with the option of providing an appreciation for the information shared by one or more end-users in the social networking system. An accumulation module stores an array of appreciations in the database which is extracted by the analysis module to establish a rank-based pattern for one or more end-users based on the significance of number of appreciations provided by one or more audience users in a pre-defined set of categories. A ranking module analyzes the rank-based pattern derived from the analysis module to generate a comprehensive ranking of the appreciations provided by compiling one or more rankings defined in a plurality of pre-defined set of categories. A notification module notifies one or more end-users and one or more audience users of the rank generated in the ranking module of the system. A matching module matches the appreciation provided by one or more audience users with the appreciation provided by one or more end-users for the corresponding information shared by the end-user and the audience user. Further, the system comprises a display unit to display the notification in the user-interface device for the rank generated by the ranking module in the social networking system.

The method for appreciating and ranking a user in a social networking system comprises the steps of interacting with one or more end-users through the user-interface device by sharing information and reacting to the information received from one or more end-users through the social networking system. One or more audience users provide an appreciation for the information shared by one or more end-users in the social networking system, wherein the information shared by one or more end-users and appreciation provided by one or more audience are stored in a database of the system. A rank-based pattern is established by the analysis module for the appreciation provided by one or more audience users in a pre-defined set of categories, thereby compiling the rank-based pattern by the ranking module to form a comprehensive ranking of one or more end-users in the social networking system.

The notification module notifies one or more end-users and one or more audience users upon the successful accomplishment of providing appreciation for the information shared by one or more end-users, thereby notifying one or more end-users and one or more audience users upon the establishment of the rank-based pattern in the social networking system. At least two users form one or more audience users and one or more end-users are matched by mapping the appreciation provided by one or more audience users and one or more end-users for the information shared in the social networking system. The matching module reveals the identity of one or more audience users to the end-user and notifies the audience user in case the appreciation provided by the end-user for the information shared by the audience user and the appreciation provided by end user for the information shared by the audience user matches. The matching module indicates the end-user by revealing the first letter of one or more audience user in case the appreciation provided by the end-user and one or more audience users does not match. The notifications generated in the social networking system are displayed in the display unit of the user-interface device.

Thus, the present invention relates to a system and method for appreciating and ranking a user in a social networking system. The system discloses a social networking system to identify the positive attributes that a user possesses and allows the user to provide an appreciation to one or more users without revealing their identity. Further, the social networking system provides a medium for one or more end-users to identify the popularity ranking of the user amongst fellow users by analyzing appreciation provided by one or more audience users for the information shared by one or more end-users, thereby compiling ranking which is established for a pre-defined set of categories and providing a real-time data to one or more users of the system. The present invention may be employed in seeking an opinion from a pre-defined group of people on a plurality of fields pertaining to the interest of the user and to aid in decision making based on the opinion gathered from a pre-defined group of people.

### BRIEF DESCRIPTION OF DRAWINGS

FIG. 1 illustrates a system to appreciate and rank a user in a social networking system.

FIG. 2 illustrates a block diagram of the system to appreciate and rank a user in a social networking system.

FIG. 3 illustrates a method for appreciating and ranking a user in a social networking system.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention relates to a system and method for appreciating and ranking a user in a social networking system. The system comprises a user-interface device to share information and react to the information shared by one or more end-users. The system comprises the processing unit to execute a set of instructions provided in a plurality of modules which are present in the system. The appreciation provided by one or more audience users for the information shared by the end-user is analyzed in the analysis module to form a rank-based pattern in the pre-defined set of categories which are compiled to form a comprehensive ranking in the ranking module. The popularity ranking of a user is displayed in the display unit of the user-interface device.

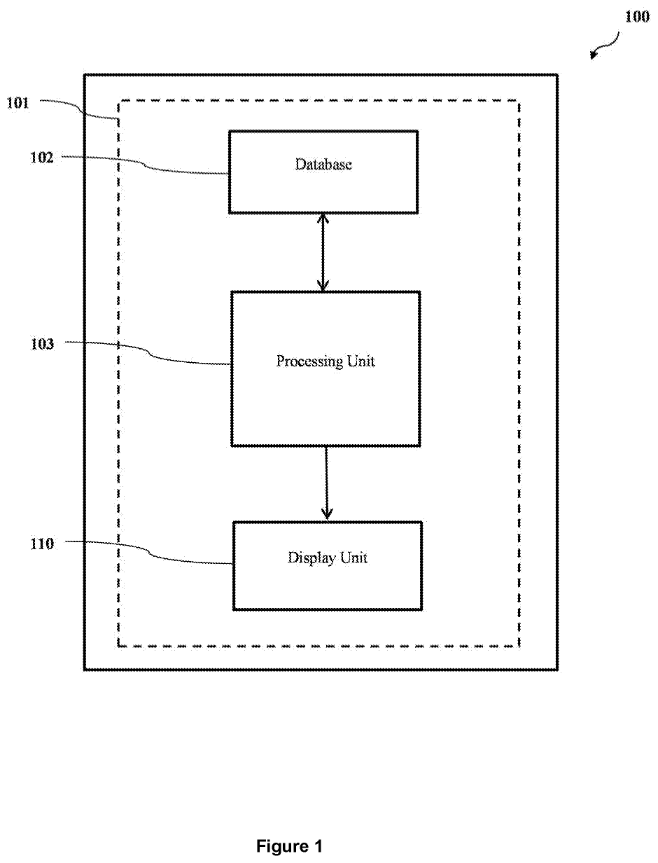

FIG. 1 illustrates a system (100) for appreciating and ranking a user in a social networking system. The system (100) comprises a user-interface device (101) such as a handheld device which may be a mobile phone, tablet and so on for one or more end-users to share information associated with an event through a social networking system and react to the information shared by one or more end-users in the social networking system. The social networking system may be employed by plurality of end-users to share information associated with an event, wherein the information shared by one or more end-users may be in the form of multi-media information, text, speech and so on. The system (100) comprises a database (102) to store the information shared by one or more end-users and the response gathered from one or more end-users for the corresponding information shared in the social networking system. The database (102) gathers the information shared by one or more end-users and one or more audience users in the social networking system from a plurality of servers. The system (100) comprises a processing unit (103) to execute a set of instructions provided in a plurality of modules such as a complimentary module (104), accumulation module (105), analysis module (106), ranking module (107), notification module (108) and a matching module (109) thereby providing a creative response by one or more audience users for the information shared by one or more end-users in the social networking system.

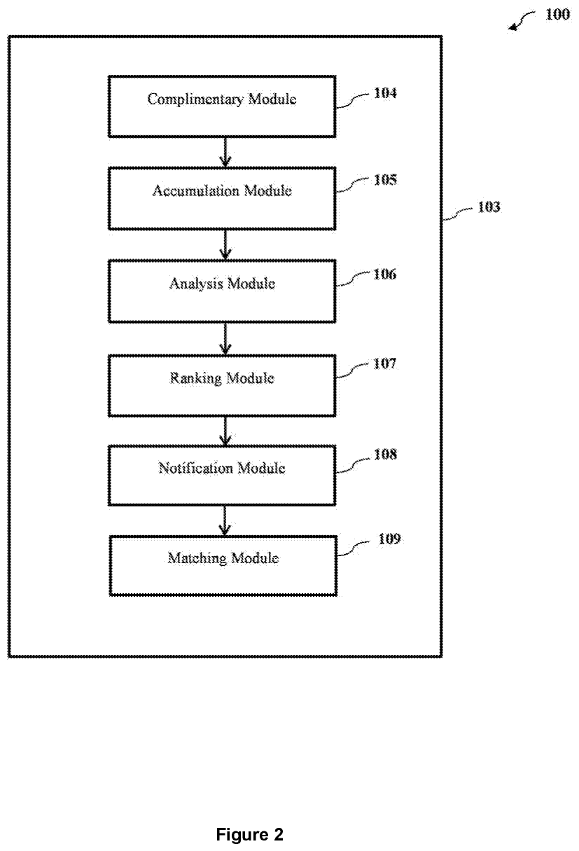

FIG. 2 illustrates a block diagram of the system (100) for appreciating and ranking a user in a social networking system. The complimentary module (104) provides one or more audience users with the option of providing an appreciation for the information shared by one or more end-users in the social networking system, wherein the audience user may be an individual receiving information shared by one or more end-users through the social networking system by using the user-interface device (101). In another embodiment, one or more audience users may react to the information shared by the end-user by providing an appreciation to the end-user which is chosen from a pre-defined list of positive characteristic gestures as per the choice of the audience user.

The accumulation module (105) stores an array of appreciations in the database (102) of the system (100), wherein the appreciation is provided by one or more audience users for the information shared by one or more end-users in the social networking system. In another embodiment, the data from one or more end-users and one or more audience users is gathered from a plurality of servers and stored in the database (102) of the system (100). The analysis module (106) processes an array of appreciations generated in a pre-defined set of categories extracted from the database (102) and establish a rank-based pattern for one or more end-users based on the significance of the number of appreciations provided to one or more end-users in a pre-defined set of categories. In another embodiment, the analysis module (106) processes each category of appreciation stored in the database (102) of the system (100) and establish a rank for a pre-defined set of categories of appreciations received by the end-user from one or more audience users.

The ranking module (107) analyzes the rank-based pattern derived from the analysis module (106) to generate a comprehensive ranking of the appreciations by compiling the ranking defined in a plurality of pre-defined categories. The notification module (108) notifies one or more end-users of the corresponding rank generated in the ranking module (107) and notifies one or more audience users of the rank generated by one or more end-users in the social networking system. The matching module (109) matches at least two users in the system (100) by mapping the appreciation of one or more audience users with the appreciation provided by one or more end-users. In another embodiment, the appreciation provided by the audience user for the information shared by the end-user is matched with the appreciation provided by the end-user for the information shared by the audience user in the preceding time.

In another embodiment of the present invention, the system (100) comprises a display unit (110) to display notifications on the user-interface device (101) corresponding to one or more end-users and one or more audience users, wherein the display unit (110) displays the notification on receiving the reaction from one or more audience users for the information shared by one or more end-users and displays the rank generated by the ranking module (107) in the social networking system.

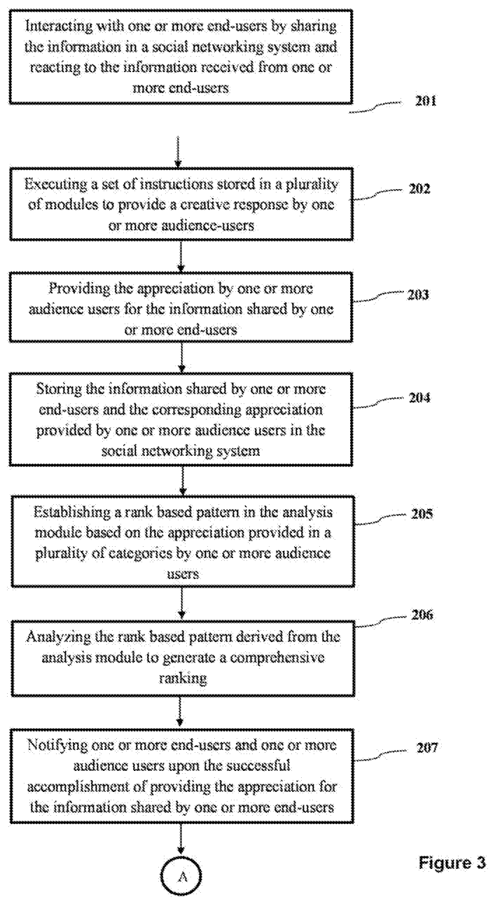

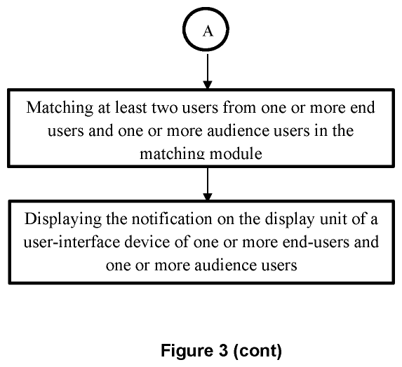

FIG. 3 illustrates a method (200) for appreciating and ranking a user in a social networking system. The method (200) comprises the steps of interacting with one or more end-users by sharing the information in the social networking system and reacting to the information received from one or more end-users in the social networking system, wherein one or more end-users share information such as photos, videos, text, audio and so on in the social networking system, in step (201). In step (202), a set of instructions are provided in the complimentary module (104), accumulation module (105), analysis module (106), ranking module (107), notification module (108) and the matching module (109) which is executed to provide a creative response such as appreciating one or more end-users by one or more audience-users from the pre-defined list of positive characteristic gestures for the information shared on the social networking system.

In step (203), the appreciation is provided by one or more audience users for the information shared by one or more end-users in the social networking system, wherein the appreciation is provided by one or more audience users from a pre-defined list of positive characteristic gestures as per the choice of one or more audience users. In another embodiment, the pre-defined list of positive characteristic gestures allow one or more audience users to choose the appropriate appreciation gesture as per the choice of one or more audience users to provide an appreciation for the information shared by one or more end-users. For example, the pre-defined list of positive characteristic gestures comprises a pre-defined set of categories such as attractive, strong personality, intelligent, trustful friend and so on. The audience user named ‘abc’ may choose “intelligent” as an appreciation gesture from the pre-defined list of positive characteristics to appreciate the information shared by the end-user named ‘xyz’. In step (204), the accumulation module (105) stores the information shared by one or more end-users and the corresponding appreciation provided by one or more audience users in the social networking system, wherein data from one or more end-users and one or more audience users is stored in the database (102) of the system (100).

A rank-based pattern is established in the analysis module (106) based on the appreciation provided from a pre-defined list of positive characteristic gestures by one or more audience users for the information shared by one or more end-users, in step (205). The analysis module (106) gathers and processes appreciations which is collected from the database (102) and multiple servers of one or more end-users, thereby generating a rank-based pattern in a pre-defined list of positive characteristic gestures based on the significance of number of appreciations provided by one or more audience users for the information shared by one or more end-users in the social networking system. For example, the analysis module (106) establishes a rank based pattern for the end-user, ‘xyz’ by providing a plurality of rankings in each categories which comprises gestures such as intelligent, attractive, strong personality and so on, wherein the rankings for the end-user, ‘xyz’ is provided by analyzing individually the number of compliments provided by one or more audience users in the above mentioned categories.

In step (206), the rank-based pattern derived from the analysis module (106) is analyzed to generate a comprehensive ranking, wherein the comprehensive ranking is generated by compiling the ranking defined in a pre-defined list of positive characteristic gestures. In another embodiment, the ranking module (107) generates a ranking by compiling the appreciations received amongst the contacts established by the end-user in the pre-defined list of positive characteristic gestures. Further, the ranking module (107) generates a ranking of the end-user amongst all the users of the system (100) by compiling the appreciations from the pre-defined list of positive characteristic gestures. For example, the ranking module (107) compiles the ranking provided to the end-user, ‘xyz’ in a plurality of categories which comprises gestures such as intelligent, attractive, strong personality and so on, thereby generating a compiled ranking of the end-user amongst his/her contacts and an additional compiled ranking is generated amongst all the users of the social networking system, wherein the ranking is generated for the end-user, ‘xyz’ by collectively analyzing the total number of appreciation provided in the above mentioned categories and comparing the total number of appreciation provided to the end-user, ‘xyz’ with the total number of appreciation provided to fellow end-users in the social networking system.

In step (207), one or more end-users and one or more audience users are notified by the notification module (108) upon the successful accomplishment of providing appreciation for the information shared by one or more end-users in the social networking system. Further, the notification module (108) notifies one or more audience-users when the end-user shares information in the social networking system. In step (208), the matching module (109) matches at least two users from one or more end-users and one or more audience users by mapping the appreciation of one or more audience users for the information shared by the end-user with the appreciation provided by the end-user for the information shared by one or more audience users in the preceding time. The matching module (109) shares the identity of the audience user to the end-user and notifies the audience user in case the appreciation provided by the audience user on the information shared by the end-user matches the appreciation provided by the end-user on the information shared by the audience user in the preceding time. For example, in case the end-user, ‘xyz’ provides “intelligent” gesture as an appreciation for the information shared by the fellow user, ‘abc’ and similarly the fellow user, ‘abc’ provides “intelligent” gesture as an appreciation for the information shared by the end-user, ‘xyz’, then the matching module (109) reveals the identity of the fellow user, ‘abc’ to the end-user, ‘xyz’ and notifies the fellow user, ‘abc’. The matching module (109) indicates the end-user by revealing the first letter of the audience user providing the appreciation in case the appreciation provided by the audience user on the information shared by the end-user and the appreciation provided by the end-user on the information shared by the audience user do not match. For example, in case the end-user, ‘xyz’ provides “intelligent” gesture as an appreciation for the information shared by the fellow user, ‘abc’ and the fellow user, ‘abc’ provides “attractive” gesture as an appreciation for the information shared by the end-user ‘xyz’, then the matching module (109) reveals the first letter i.e, ‘a’ of the fellow user, ‘abc’ to the end user, ‘xyz’, since the appreciation provided by the fellow user, ‘abc’ and the end-user, ‘xyz’ does not match.

In step (209), the display unit (110) of the user-interface device (101) displays the notification to one or more end-users and one or more audience users, wherein the display unit (110) displays the notification to one or more end-users on receiving the reaction from one or more audience users. Further, the display unit (110) displays the information shared by one or more end-customer in the social network system and the rank generated by the ranking module (107) based on the appreciation received from one or more audience users.

In another embodiment, one or more end-users share information from the user-interface device (101) through the social networking system, wherein the information shared by one or more end-users reaches one or more audience users of the social networking system. In another embodiment, the end-user may share the information among his contacts in the social networking system and prevent one or more unidentified audience users from viewing the content. One or more audience users may react to the information shared by the end-user by providing an appreciation to the information shared by the end-user, wherein the audience user is provided with the option of choosing the appreciation from the pre-defined list of positive characteristic gestures as per the choice of the audience user. The system (100) does not reveal the identity of the audience user to one or more end-users unless there is a successful match in the appreciation provided by the audience user and the end-user. The information shared by the end-user and the appreciation provided by one or more audience users is stored in the database (102), wherein the database (102) excludes any recurrence of similar gesture provided by the audience user. Further, the data stored in the database (102) is transmitted to a processing unit (103) which processes the data thereby establishing a rank-based pattern of the end-user for the appreciation provided by one or more audience users. In one embodiment, the ranking is established for the pre-defined list of positive characteristic gestures for one or more end-users on the basis of the number of appreciations provided by one or more audience users which is stored in the database (102) of the system (100). The ranking established in the pre-defined list of positive characteristic gestures in the processing unit (103) is compiled to form a comprehensive ranking of the end-user amongst the pre-defined list of fellow end-users. Further, the ranking established in a pre-defined list of positive characteristic gestures for a plurality of end-users is compiled to form a comprehensive ranking by considering overall end-users of the system (100). The ranking generated amongst the pre-defined list of fellow end-users and overall end-users of the system (100) is published in the social networking system which is displayed through the display unit (110) of user-interface device (101), thereby identifying popularity ranking of a user in the social networking system which notifies one or more end-users and one or more audience users of the system (100).

Thus, the present invention relates to a system (100) and method (200) for appreciating and ranking a user in a social networking system. The system (100) discloses a social networking system to identify the positive attributes that a user possesses and allows the user to provide an appreciation to one or more users without revealing their identity. Further, the social networking system provides a medium for one or more end-users to identify the popularity ranking of the user amongst fellow users by analyzing the appreciation provided by one or more audience users for the information shared by one or more end-users, thereby compiling ranking which is established for a pre-defined set of categories and providing a real-time data to one or more users of the system (100). The present invention may be employed in seeking an opinion from a pre-defined group of people on a plurality of fields pertaining to the interest of the user and to aid in decision making based on the opinion gathered from a pre-defined group of people.

The features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

### REFERENCE NUMBERS

| Components | Reference Numbers |
|---|---|
| User-interface Device | 101 |
| Database | 102 |
| Processing Unit | 103 |
| Complimentary Module | 104 |
| Accumulation Module | 105 |
| Analysis Module | 106 |
| Ranking Module | 107 |
| Notification Module | 108 |
| Matching Module | 109 |
| Display Unit | 110 |

We claim:

1. A system (100) to appreciate and rank a user in a social networking system, the system (100) comprising:
a. a user-interface device (101) comprising a social networking system to share and react to information associated with one or more events;
b. a database (102) to store the shared information associated with an event of one or more end-users, wherein the database (102) gathers the information shared by one or more end-users and one or more audience users in the social networking system from a plurality of servers;
c. a processing unit (103) to process and execute a set of instructions provided in:
i. a complimentary module (104) for providing one or more audience users with the option of providing an appreciation for the information shared by one or more end-users in the social networking system;
ii. an accumulation module (105) for storing an array of appreciations provided by one or more audience users in the database (102) for the information shared by one or more end-users in the social networking system;
iii. an analysis module (106) for processing an array of appreciations extracted from the database (102) and establish a rank-based pattern for one or more end-users based on the significance of the number of appreciations provided to one or more end-users in a pre-defined set of categories;
iv. a ranking module (107) for analyzing the rank-based pattern derived from the analysis module (106) to generate a comprehensive ranking of the appreciations by compiling the ranking defined in a pre-defined set of categories;
v. a notification module (108) for notifying one or more end-users and one or more audience users of the corresponding rank generated in the ranking module (107);
vi. a matching module (109) for matching at least two users in the system (100) by mapping the appreciation provided by one or more audience users with the appreciation provided by one or more end-users for the corresponding information shared by the end-user and the audience user; and
d. a display unit (110) to display the notification corresponding to one or more end-users and one or more audience users on a user-interface device (101), wherein the display unit (110) displays the rank generated by the ranking module (107) in the social networking system.

2. The system (100) as claimed in claim 1, wherein the complimentary module (104) provides an option from a pre-defined list of positive characteristic gestures to one or more audience users to react for the information shared on the social networking system by one or more end-users.

3. A method (200) for appreciating and ranking a user in a social networking system, the method (200) comprising the steps of:
a. interacting with one or more end-users by sharing information in a social networking system and reacting to the information received from one or more end-users in the social networking system;
b. executing a set of instructions provided in the complimentary module (104), accumulation module (105), analysis module (106), ranking module (107), notification module (108) and matching module (109) to provide a creative response by one or more audience-users for the information shared on the social networking system by one or more end-users;
c. providing the appreciation by one or more audience users for the information shared by one or more end-users from the pre-defined list of positive characteristic gestures in the social networking system;
d. storing the information shared by one or more end-users and the corresponding appreciation provided by one or more audience users in the social networking system, wherein the data from one or more end-users and one or more audience users is accumulated in the database (102) of the system (100);
e. establishing a rank-based pattern in the analysis module (106) based on the appreciation provided from a pre-defined list of positive characteristic gestures by one or more audience users for the information shared by one or more end-users;
f. analyzing the rank-based pattern derived from the analysis module (106) to generate a comprehensive ranking, wherein the rank-based pattern gathered from a pre-defined list of positive characteristic gestures is compiled based on the significance of number of appreciations provided by one or more audience users for the information shared by one or more end-users in the social networking system;
g. notifying one or more end-users and one or more audience users upon the successful accomplishment of providing appreciation for the information shared by one or more end-users in the social networking system;
h. matching at least two users from one or more end users and one or more audience users in the matching module (109) by mapping the appreciation of one or more audience users with the appreciation provided by one or more end-users for the corresponding information shared by one or more audience users, wherein;
i. the matching module (109) shares the identity of the audience user to the end-user and notifies the audience user in case the appreciation provided by the audience user for the information shared by the end user and the appreciation provided by the end-user for the information shared by the audience user matches;
ii. the matching module (109) indicates the end-user by revealing the first letter of the audience user providing the appreciation in case the appreciation provided by the audience user and the appreciation provided by the end-user do not match; and
i. displaying the notification on the display unit (110) of the user-interface device (101) of one or more end-users and one or more audience users, wherein the display unit (110) displays the notification to one or more end-users on receiving the reaction from one or more audience users and displays the rank generated by the ranking module (107) based on the appreciation provided by one or more end-users.

4. The method (200) as claimed in claim 5, wherein the pre-defined list of positive characteristic gestures allows one or more audience users to select an appropriate appreciation gesture as a reaction to the information shared by one or more end-users.

5. The method (200) as claimed in claim 5, wherein the ranking of the appreciations gathered by the analysis module (106) is established based on the significance of the number of appreciations received for the information shared by one or more end-users.
